(19) United States
(12) Patent Application Publication
(10) Pub. No.: US 2018/0370555 A1
(43) Pub. Date: Dec. 27, 2018

(54) Stroller

(71) Applicant: Samantha Lian Morrell, Mindarie (AU)

(72) Inventors: Samantha Lian Morrell, Mindarie (AU); Edward Joseph Khoury, Bateman (AU); Allister HODSON, Bibra Lake (AU)

(21) Appl. No.: 15/774,971

(22) PCT Filed: Nov. 7, 2016
(86) PCT No.: PCT/AU2016/051065

§ 371 Date: May 9, 2018

(30) Foreign Application Priority Data
Nov. 9, 2015 (AU) 2015904589
Jul. 13, 2016 (AU) 2016902759

(51) Int. Cl. B62B 7/12; A47D 1/06

(52) U.S. Cl. CPC B62B 7/12; A47D 1/06

(57) ABSTRACT

A stroller (10) comprising front wheel support members (24) and rear wheel support members (250, each having a wheel unit (14, 15) secured to a lower end thereof. Front and rear legs (18, 20) are secured to the front and rear wheel support members (24, 25) respectively. The front and rear legs (18, 20) are each moveable longitudinally from a retracted position, in which the legs (18, 20) are adjacent and parallel to the respective wheel support members (24, 25) with a lower end thereof located above the respective wheel unit (14, 15), to an extended position, in which the lower ends thereof are located below the respective wheel units (14, 15) such that the stroller (10) is supported by the front and rear legs (18, 20).

### FIELD OF THE INVENTION

The present invention relates to a stroller.

### BACKGROUND TO THE INVENTION

When travelling with small children, it is usual to take a stroller. When it is necessary to feed the child, unless a separate high chair has also been taken, it is common to simply feed the child while he or she is seated in the stroller. As the seats in strollers are positioned relatively low, this will generally require the adult to lean forward, which can be uncomfortable. It also does not allow the child to sit up at the height of a table.

Many restaurants provide high chairs which can be used for small children, as an alternative to feeding in a stroller. However, such high chairs are often relatively inexpensive chairs that may not be particularly comfortable or easy to use. Also, hygiene is a potential issue as these high chairs are often not cleaned after every use.

The present invention relates to a stroller having features aimed at making the stroller more suitable for feeding a child seated in the stroller. The stroller comprises a simple construction which is easy to convert between the stroller and chair configurations.

### SUMMARY OF THE INVENTION

According to one aspect of the present invention there is provided a stroller comprising:

first and second front wheel support members, each having a front wheel unit secured to a lower end thereof, and first and second rear wheel support members, each having a rear wheel unit secured to a lower end thereof;
first and second front legs secured to the first and second front wheel support members respectively; and
first and second rear legs secured to the first and second rear wheel support members respectively;
wherein the front and rear legs are each moveable longitudinally from a retracted position, in which the legs are adjacent and parallel to the respective wheel support members with lower ends thereof located above the respective wheel units, to an extended position, in which the lower ends thereof are located below the respective wheel units such that the stroller is supported by the front and rear legs.

Preferably each of the front and rear wheel support members comprises an elongate member and each of the front and rear legs comprises an elongate member mounted parallel to the respective wheel support member and being slidably moveable relative to the respective wheel support member to move between the retracted and extended positions.

Preferably each of the front and rear legs includes an extension mechanism connecting the leg to the adjacent wheel support member, wherein the extension mechanism is operable to move the leg between the extended and retracted positions.

In a preferred embodiment, the rear legs extend such that the lower ends thereof are located at a greater distance from the rear wheel units than the front legs are from the front wheel units such that the seat of the stroller rotates from a more reclined position to a more upright position when the legs move from the retracted to the extended position.

Preferably each of the front and rear legs is provided with a sleeve secured to the respective wheel support member, the sleeves comprising tubular members secured to the wheel support members such that the legs can slide in and out of the lower ends of the sleeve.

Preferably the legs are securable relative to the sleeves by locking members.

Preferably levers are provided adjacent the lower ends of the sleeves operable to disengage the locking members and allow the legs to slide from the retracted position to the extended position and from the extended position to the retracted position.

Preferably the legs are provided with spring biased lugs which extend through holes in the legs and engage into corresponding holes in the sleeves to secure the legs and wherein the levers are provided to depress the lugs to allow the legs to move relative to the sleeves.

Preferably elastic cords are provided connecting the legs to the sleeves such that the legs are biased to move towards the retracted position.

In a preferred embodiment, the sleeves are moveable between first and second positions, such that lower ends of the sleeves move outwardly away from opposed sides of the stroller when moving from the first to the second position.

Preferably the sleeves are pivotally mounted at upper ends thereof to the front and rear wheel support members to pivot between the first and second positions.

Preferably the front and rear wheel support members are provided with mounting members secured thereto, the mounting members including recesses in lower sides thereof into which are received the upper ends of the sleeves such that upper ends of the sleeves are pivotally secured to pins extending across the recesses.

Preferably each of the sleeves pivots between the first position in which the sleeve is adjacent and parallel to the respective wheel support member and the second position in which the sleeve extends at an angle to the wheel support member.

Preferably each of the sleeves is provided with an extension member adjacent the lower end thereof, the extension members connecting between the wheel support member and the sleeve such that the extension member moves the sleeve between the first and second positions.

In a preferred embodiment, the extension member comprises a first arm portion and a second arm portion, a first end of the first arm portion being pivotally mounted to the wheel support member, a second end of the first arm portion being pivotally secured to the second arm portion and a second end of the second arm portion being pivotally secured to the sleeve.

Preferably the first and second arm portions can move between a first position in which the arm portions are adjacent and parallel to each other, and a second position, in which the arm portions are collinear and extend outwardly from the wheel support member to the sleeve.

In a further embodiment, the sleeves comprise brackets secured adjacent lower ends of the wheel support members and the extension mechanism comprises a first link member and a second link member, the first link member being pivotally secured at a first end thereof to the leg and the second link member being pivotally secured to the first link member and the adjacent wheel support member, wherein the first and second link members are pivotable relative to each other from a first position, in which the first and second link members are adjacent each other, to a second position, in which the first and second link members extend generally away from each other to move the legs to the extended positions.

Preferably the frame is provided with a table secured between the first and second front wheel support members such that the table is located in front of the seat.

### BRIEF DESCRIPTION OF THE DRAWINGS

The invention will now be described, by way of example, with reference to the following drawings, in which:

FIG. 1a is an upper perspective view of a stroller in accordance with the present invention, with the legs in a retracted position;

FIG. 1b is an upper perspective view of the stroller of FIG. 1a with the legs in an extended position;

FIG. 2a is an upper perspective view of the stroller of FIG. 1;

FIG. 2b is a close up of Detail A of FIG. 2a;

FIG. 3a is an upper perspective view of the stroller of FIG. 1;

FIG. 3b is a close up of Detail B of FIG. 3a;

FIG. 4a is an upper perspective view of the stroller of FIG. 1;

FIG. 4b is a close up of Detail C of FIG. 4a;

FIG. 5a is an upper perspective view of the stroller of FIG. 1;

FIG. 5b is a close up of Detail D of FIG. 5a;

FIG. 6a is an upper perspective view of the stroller of FIG. 1;

FIG. 6b is a close up of Detail E of FIG. 6a;

FIG. 7 is an exploded view of one of the sleeves of the stroller of FIG. 1;

FIG. 8 is an exploded view of one of the legs of the stroller of FIG. 1;

FIG. 9 is an exploded view of the legs of the stroller of FIG. 1;

FIG. 10 is an upper perspective view of a second embodiment of a stroller in accordance with the present invention with the legs in retracted positions;

FIG. 11 is a side view of the stroller of FIG. 10;

FIG. 12a is a side view of the stroller of FIG. 10;

FIG. 12b is a close up view of Detail A of FIG. 12a;

FIG. 13a is a side view of the stroller of FIG. 10;

FIG. 13b is a close up view of Detail B of FIG. 13a;

FIG. 14 is an upper perspective view of the stroller of FIG. 10 with the legs in extended positions;

FIG. 15 is a side view of the stroller of FIG. 10 with the legs in the extended positions;

FIG. 16a is a side view of the stroller of FIG. 10 with the legs in the extended positions;

FIG. 16b is a close up view of Detail D of FIG. 16a;

FIG. 17a is a side view of the stroller of FIG. 10 with the legs in the extended positions;

FIG. 17b is a close up view of Detail E of FIG. 17a;

FIG. 18a is a side view of the stroller of FIG. 10 with the legs in the extended positions;

FIG. 18b is a close up view of Detail C of FIG. 19a;

FIG. 19 is a side view of a third embodiment of a stroller in accordance with the present invention;

FIG. 20 is a front view of the stroller of FIG. 19;

FIG. 21 is an upper perspective view of the stroller of FIG. 19 with the legs in the extended position;

FIG. 22 is a front view of the stroller of FIG. 19 with the legs in the extended position;

FIG. 23 is a side view of the stroller of FIG. 19 with the legs in the extended position;

FIG. 24a is a rear view of the stroller of FIG. 19 with the legs in the retracted position;

FIG. 24b is a close up view of Detail B of FIG. 24a;

FIG. 25a is a front view of the stroller of FIG. 19 with the legs in the retracted position;

FIG. 25b is a close up view of Detail C of FIG. 25a;

FIG. 26a is a side view of the stroller of FIG. 19 with the legs in the retracted position; and

FIG. 26b is a close up view of Detail A of FIG. 26a.

### DETAILED DESCRIPTION OF PREFERRED EMBODIMENTS

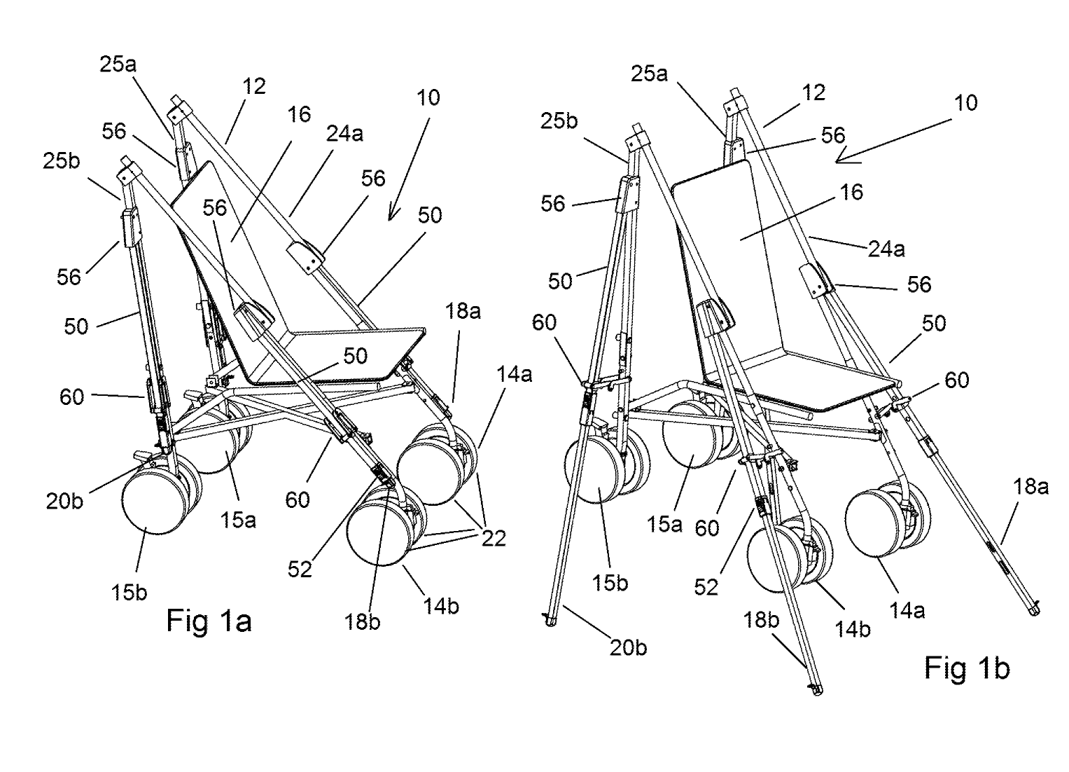

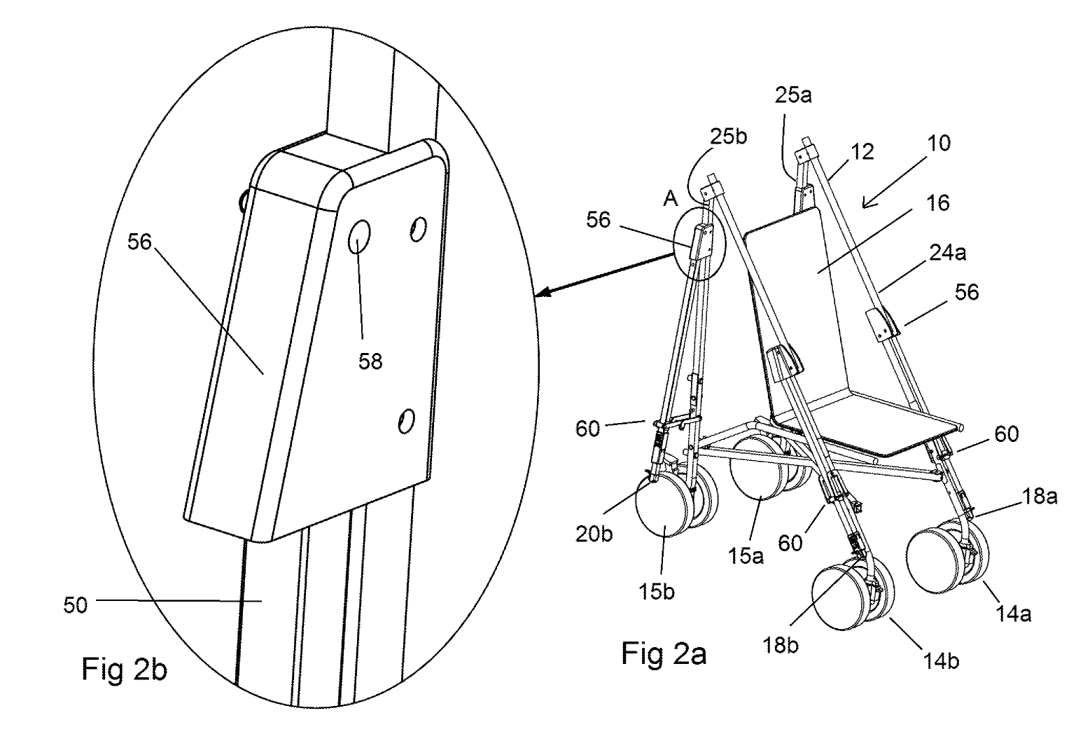

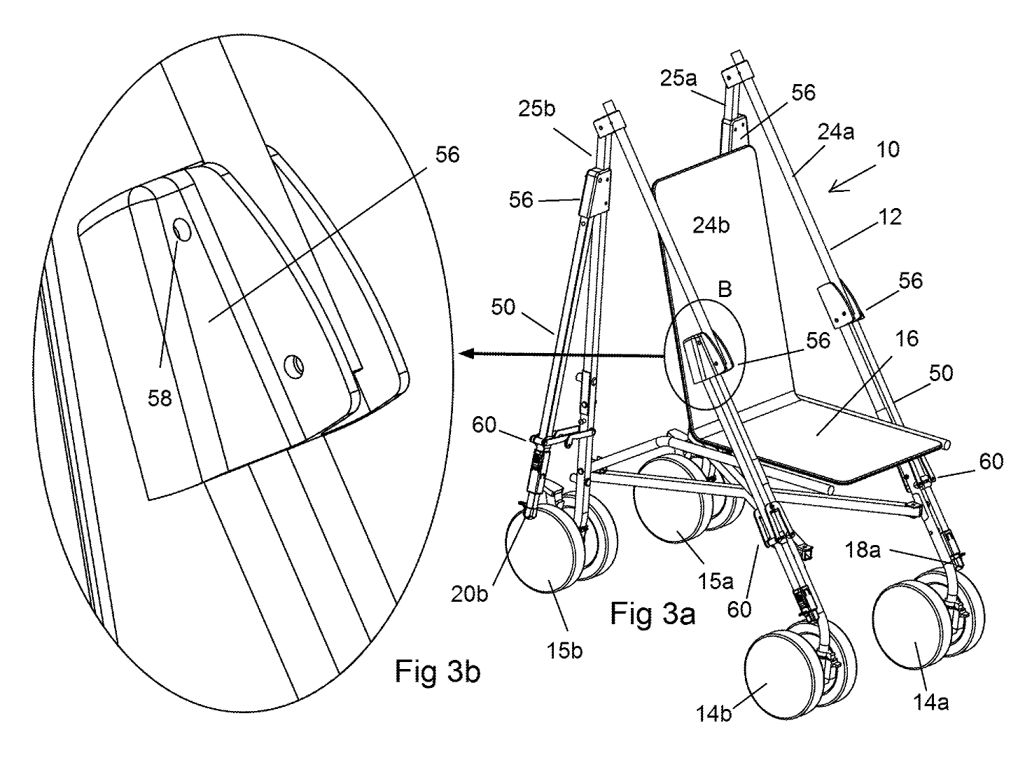

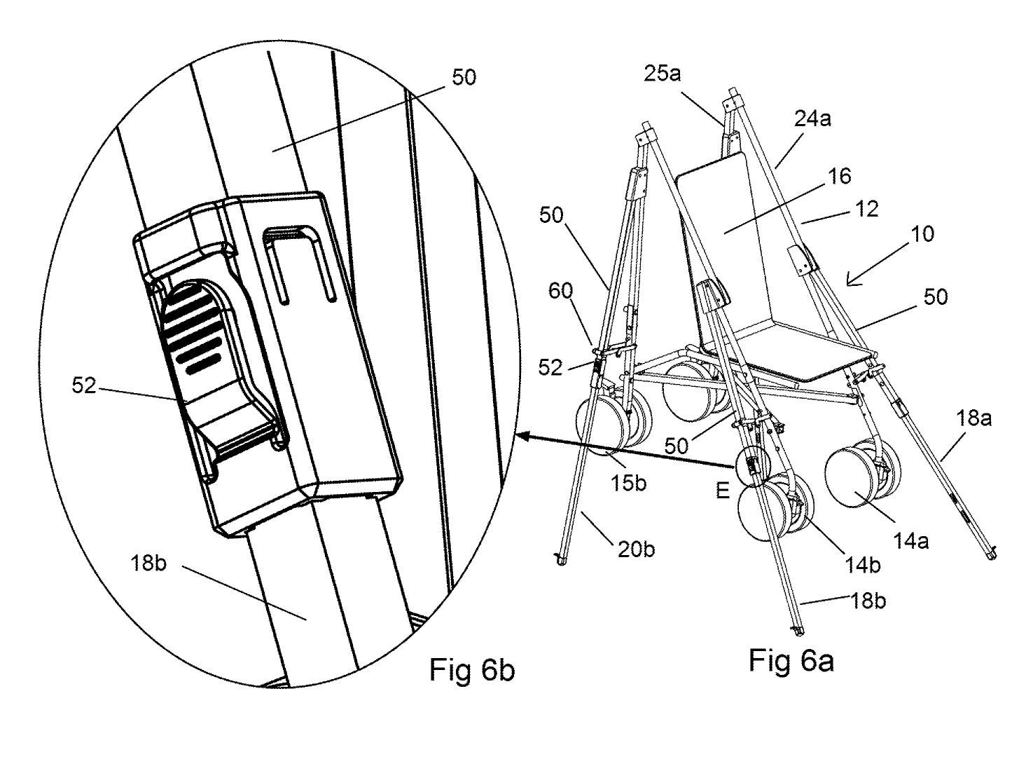

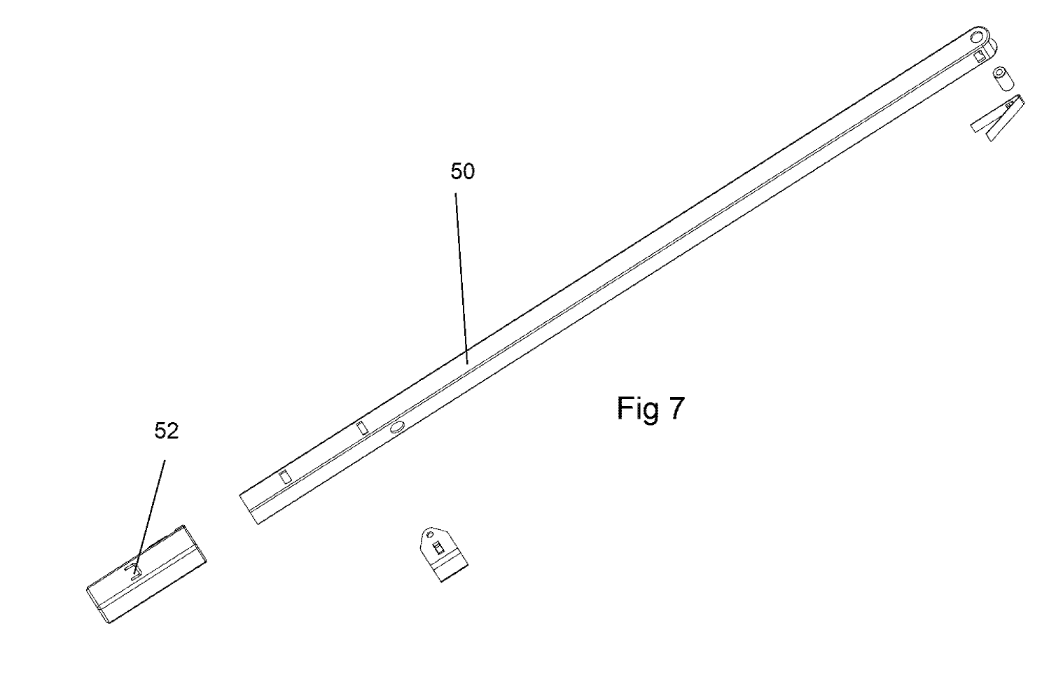

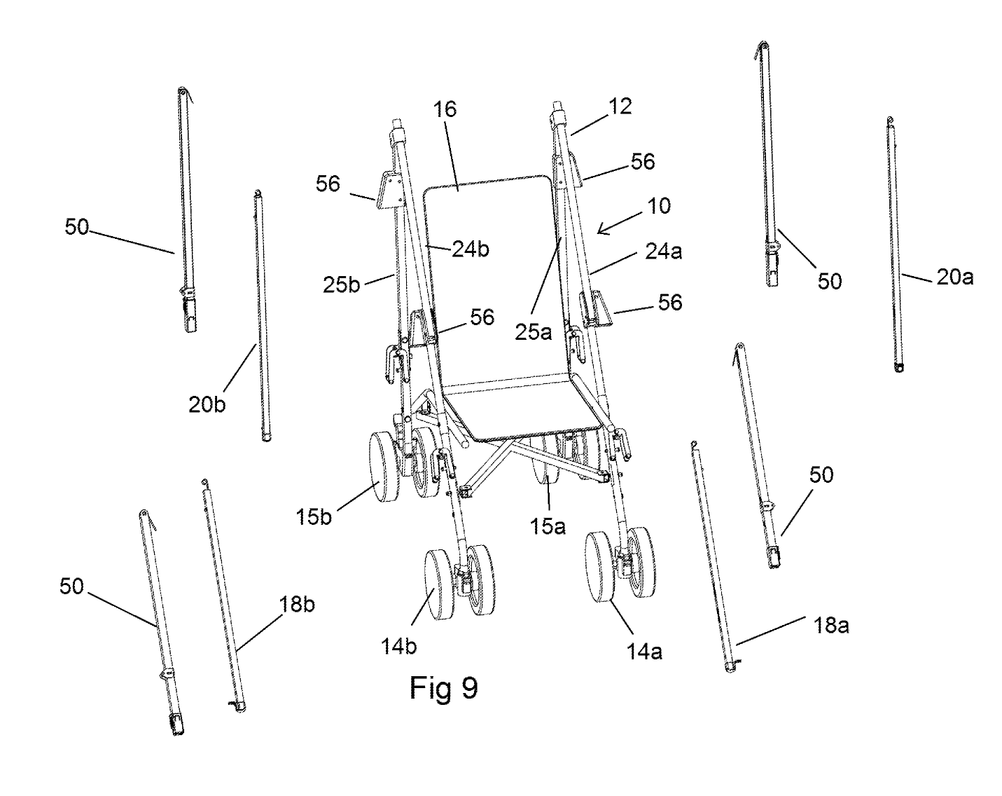

Referring to FIGS. 1 to 9, there is shown a stroller 10 comprising generally a frame 12 supported on wheel units. In particular, the frame 12 includes first and second front wheel units 14a and 14b and first and second rear wheel units 15a and 15b. The frame 12 includes also a seat 16 in which a child may sit.

The frame 12 of the stroller 10 comprises a generally known construction. The frame 12 includes first and second front wheel support members 24a and 24b and first and second rear wheel support members 25a and 25b. Each of the front wheel support members 24a and 24b comprises an elongate member located adjacent a front side of the frame 12. The first and second front wheel units 14a and 14b are secured to lower ends of the first and the second front wheel support members 24a and 24b. Each of the rear wheel support members 25a and 25b comprises an elongate member located adjacent a rear side of the frame 12. The first and second rear wheel units 15a and 15b are secured to lower ends of the first and second rear wheel support members 25a and 25b. In the embodiment shown, the wheel units 14 and 15 each comprise a pair of wheels 22 mounted parallel to each other about an axle such that a gap is defined between the wheels 22.

The first front wheel support member 24a is secured adjacent an upper end thereof to the first rear wheel support member 25a. The second front wheel support member 24b is secured adjacent an upper end thereof to the second rear wheel support member 25b. The front wheel support members 24 are pivotally secured to the rear wheel support members 25 such that the stroller 10 may be moved between an open position (as shown in the Figures) and a collapsed position in a known manner. In the collapsed position the front wheel support members 24 and pivoted toward the rear wheel support members 25. The seat 16 comprises a seat frame and material base which is also collapsible when the stroller 10 is in the collapsed position.

The frame 12 is provided also with a table 34. The table 34 is secured between the first and second front wheel support members 24a and 24b such that the table 34 is located in use in front of the seat 16.

The stroller 10 includes also first and second front legs 18a and 18b and first and second rear legs 20a and 20b. Each of the front legs 18a and 18b comprises an elongate member. The first front leg 18a is secured adjacent and parallel to the first front wheel support member 24a. The second front leg 18b is secured adjacent and parallel to the second front wheel support member 24b.

Each of the rear legs 20a and 20b also comprises an elongate member. The first rear leg 20a is secured adjacent to the first rear wheel support member 25a. The second rear leg 20b is secured adjacent to the second rear wheel support member 25b.

Each of the front legs 18 includes a lower end located adjacent the respective front wheel unit 14 and an upper end located adjacent the respective front wheel support member 24 between a lower and an upper end thereof. Each of the rear legs 20 also includes a lower end located adjacent the respective rear wheel unit 15 and an upper end located adjacent the respective rear wheel support member 25 between a lower and an upper end thereof.

Each of the front and rear legs 18 and 20 is movable between a retracted position (as shown in FIG. 1a) and an extended position (as shown in FIG. 1b). In the retracted positions, the lower ends of the front and rear legs 18 and 20 are located above the ground adjacent the respective front and rear wheel units 14 and 15. In the extended positions, the lower ends of the front and rear legs 18 and 20 extend below the front and rear wheel units 14 and 15 such that the lower ends of the front and rear legs 18 and 20 engage with the ground. As can be seen in FIG. 1b, the stroller 10 is thereby raised off the ground and rests on lower ends of the front and rear legs 18 and 20. The legs 18 and 20 are located adjacent the respective wheel support members 24 and 25 in the retracted position and move longitudinally downwardly relative to the wheel support members 24 and 25 to the extended positions.

As can be seen, for example in FIG. 1b, the rear legs 20 extend such that the lower ends thereof are located at a greater distance from the rear wheel units 15 than the front legs 18 are from the front wheel units 14. With the legs 18 and 20 in the retracted position, the seat 16 is oriented in a slightly reclined position, as is generally the case for strollers 10. With the stroller 10 resting on the legs 18 and 20, the seat 16 is in a more upright position, being more suitable for use as a high chair rather than a stroller.

Each of the front and rear legs 18 and 20 is provided with an extension mechanism to be used to move the legs 18 and 20 between the retracted and extended positions. The extension mechanism is provided to cause longitudinal movement of the front and rear legs 18 and 20 to move the legs 18 and 20 between the retracted and extended positions.

The stroller 10 of FIGS. 1 to 9 includes front legs 18 provided with sleeves 50 secured to the respective wheel support members 24 and 25. The sleeves 50 comprise tubular members secured to the front wheel support members 24 such that the legs 18 can slide in and out of the lower ends thereof.

The front legs 18 are securable relative to the sleeves 50 by locking members. The locking members are operable by levers 52 provided adjacent the lower ends of the sleeves 50. The levers 52 are moveable to release the locking members and thereby allow the front legs 18 to slide from the retracted position to the extended position and back.

The rear legs 20 are provided in the same configuration as the front legs 18. That is, the rear legs 20 are slidable within sleeves 50 secured parallel and adjacent the rear wheel support members 25.

The sleeves 50 are pivotally mounted at upper ends thereof to the front and rear wheel support members 24 and 25. The front and rear wheel support members 24 and 25 are provided with mounting members 56 secured thereto. The mounting members 56 include recesses in lower sides thereof into which are received the upper ends of the sleeves 50. Pins 58 passing across the recesses in the mounting members 56 pass through holes in the upper ends of the sleeves 50 such that the sleeves 50 may pivot about the pins 58.

Each of the sleeves 50 may therefore pivot between a first position (as shown in FIG. 1a) in which the sleeve 50 is adjacent and parallel to the respective wheel support member 24 or 25, and a second position (as shown in FIG. 1b) in which the sleeve 50 extends at an angle to the wheel support member 24 or 25. In the second position, lower ends of the sleeves 50 move away from opposed sides of the stroller 10.

Each of the sleeves 50 is provided with an extension member 60 adjacent the lower end thereof. The extension members 60 connect between the wheel support member 24 or 25 and the sleeve 50 such that the extension member 60 may move the sleeve 50 between the first and second positions. In the embodiment shown, the extension member 60 comprises a first arm portion 62 and a second arm portion 63. The first arm portion 62 includes a first end pivotally mounted to the wheel support member 24 or 25. A first end of the second arm portion 63 is pivotally secured to the second end of the first arm portion 62. A second end of the second arm portion 63 is pivotally secured to the sleeve 50.

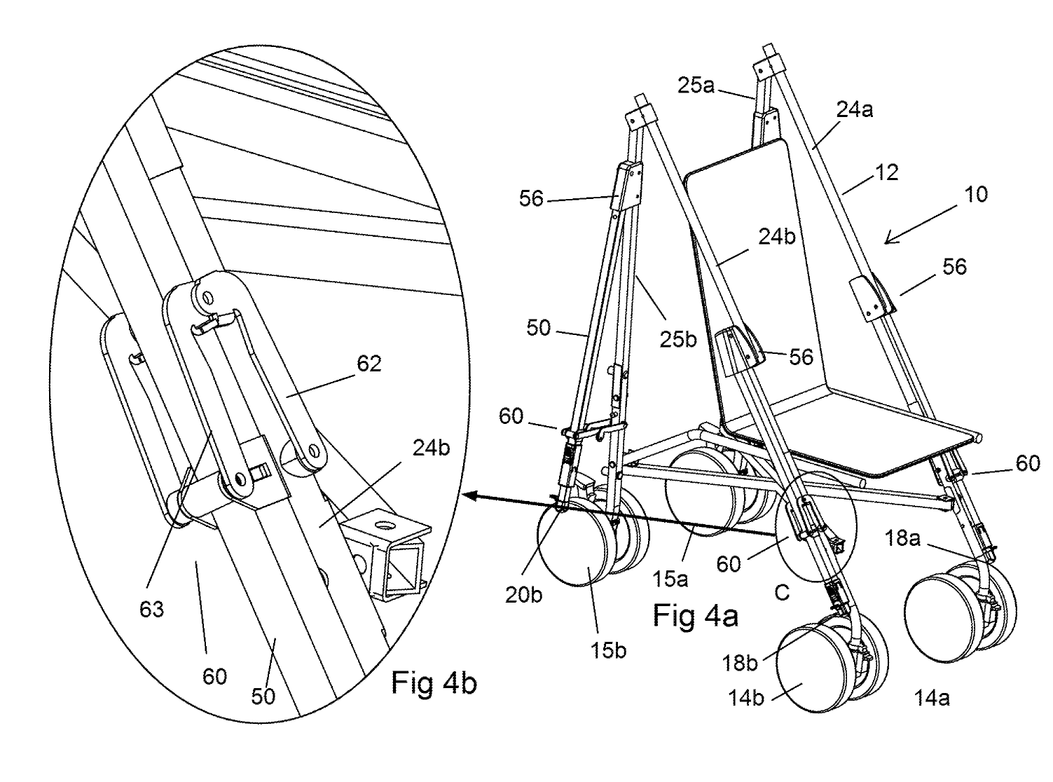

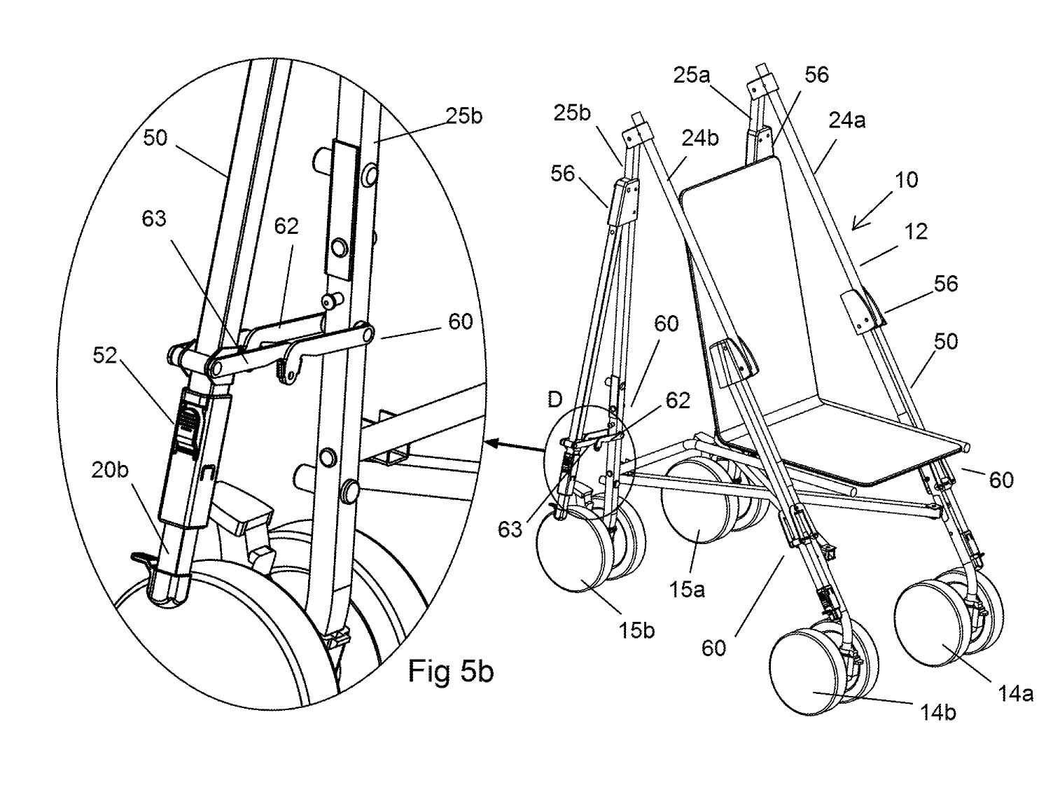

The first and second arm portions 62 and 63 can therefore move between a first position (as shown in FIG. 4) in which the arm portions 62 and 63 are adjacent and parallel to each other, the sleeve 50 and the wheel support member 24 or 25, and a second position (as shown in FIG. 5), in which the arm portions 62 and 63 are collinear and extend outwardly from the wheel support member 24 to the sleeve 50.

When the first and second arm portions 62 and 63 are moved to the second positions thereof, the sleeves 50 are pivoted outwardly away from the wheel support members 24 and 25 to the second positions thereof. In this position, the legs 18 and 20 may be extended outwardly from sleeves 50 to the extended positions (as can be seen in FIG. 1b).

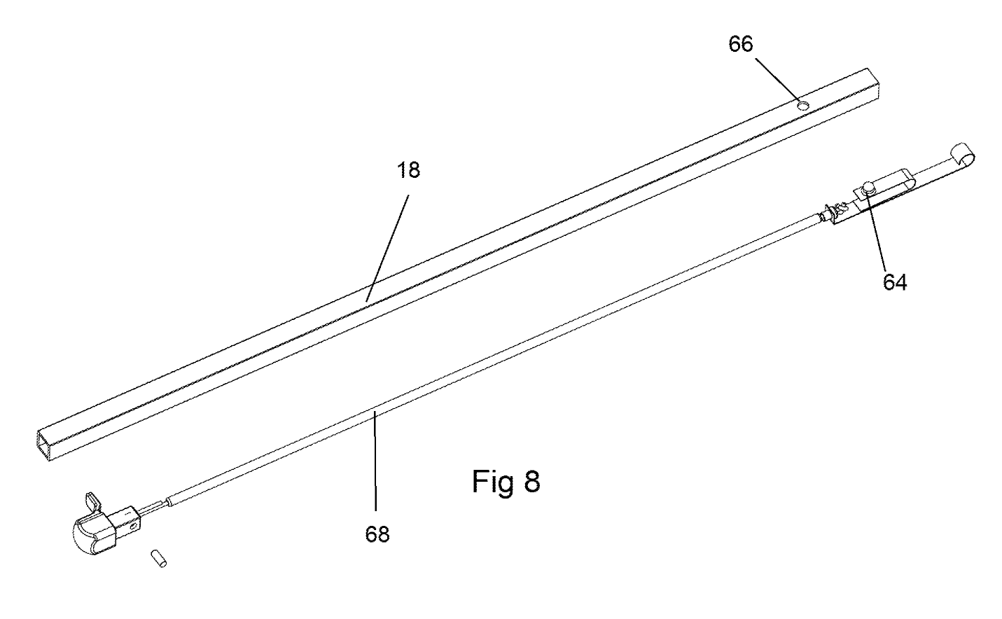

The locking members comprise spring biased lugs 64 (as can be seen in FIG. 8) which extend through holes 66 in the legs 18 and 20 to engage into corresponding holes in the sleeves 50 to secure the legs 18 and 20 in the extended or retracted positions. The levers 52 provided adjacent the ends of the sleeves 50 depress the lugs 64 and allow sliding of the legs 18 and 20 relative to the sleeves 50. Elastic cords 68 are provided connecting the legs 18 to the sleeves 50 such that the legs 18 are biased to move towards the retracted position.

In use, the stroller 10 may be utilised in the normal manner with the front and rear legs 18 and 20 in the retracted positions. If it is required to use the stroller 10 in the manner of a high chair, the extension mechanisms of the front and rear legs 18 and 20 are operated to move the front and rear legs 18 and 20 from the retracted to the extended positions. The stroller 10 then rests on the front and rear legs 18 and 20 with the seat 16 in a higher, more upright position.

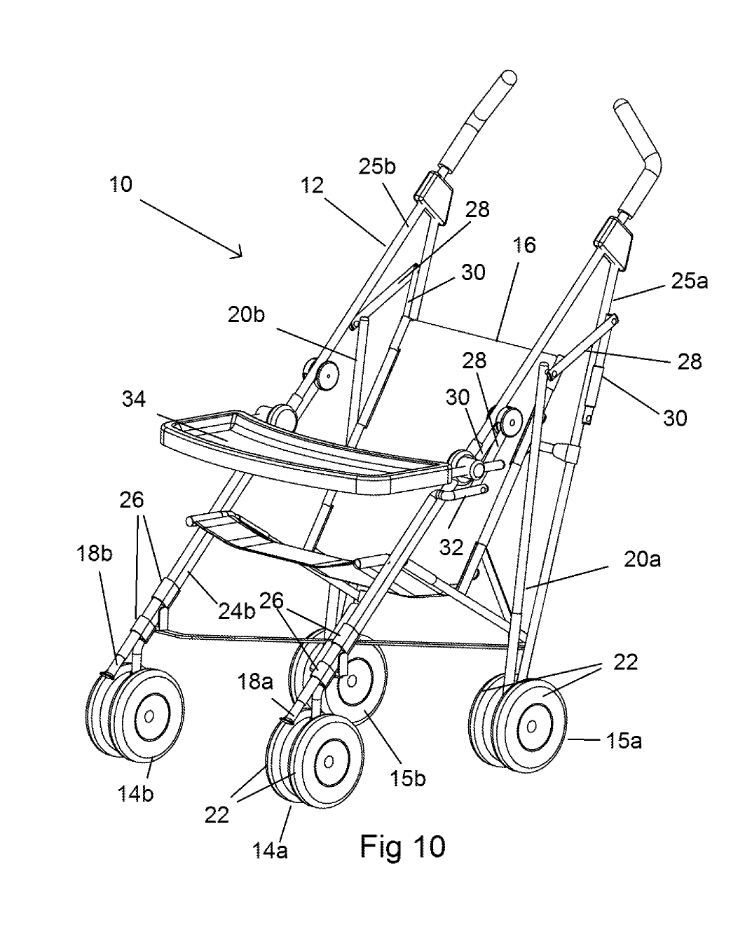

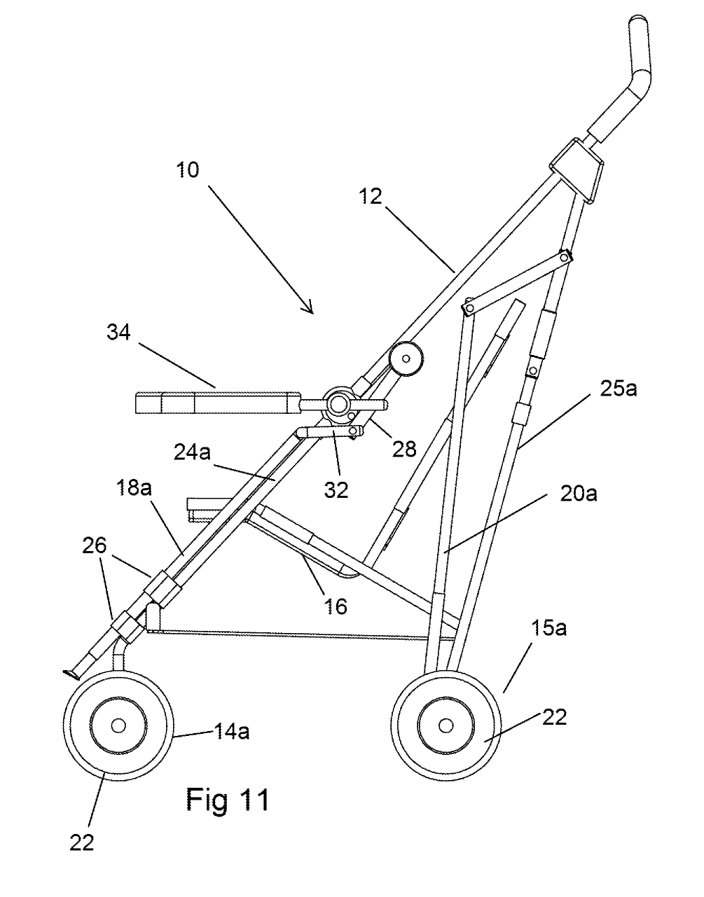

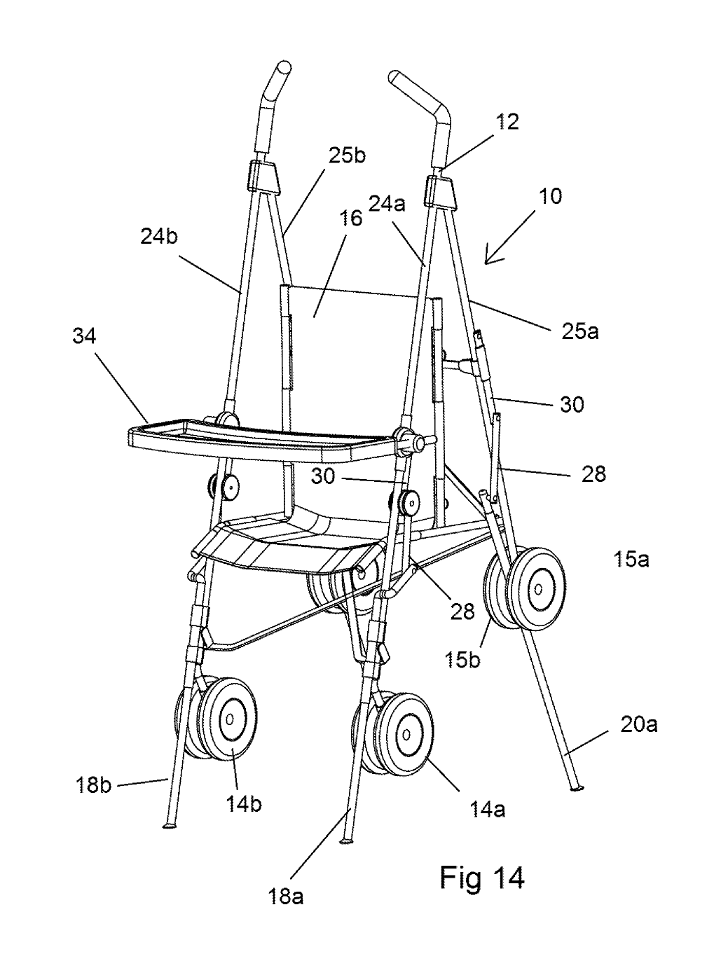

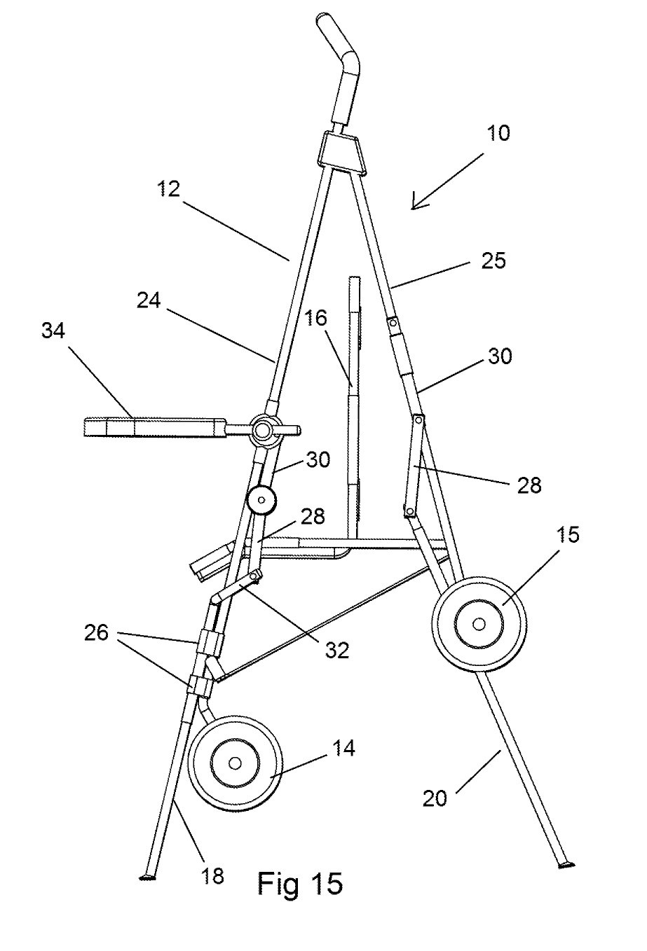

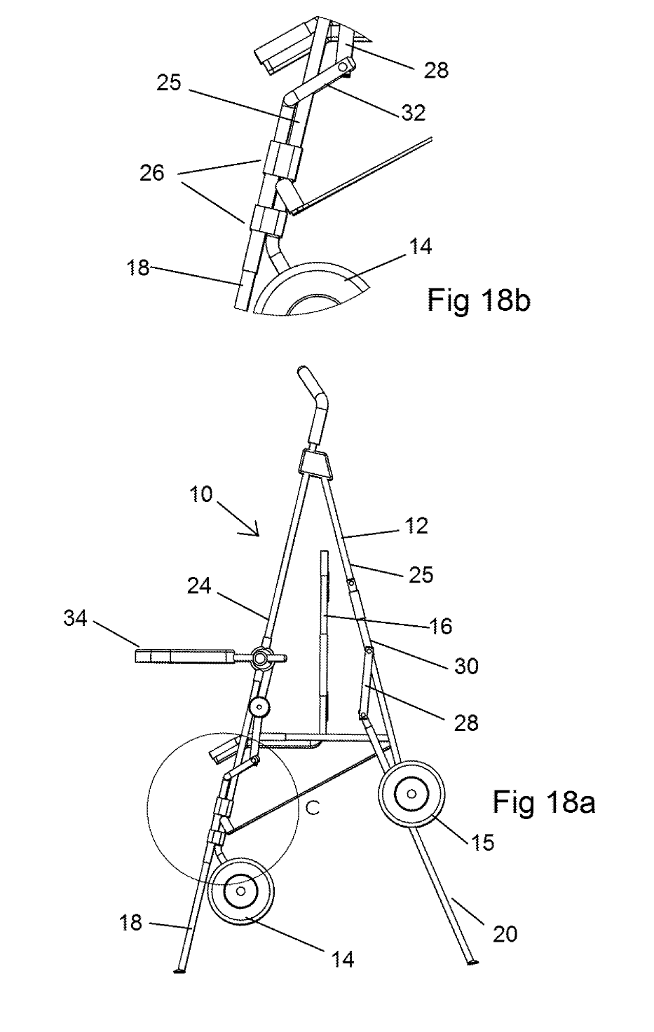

FIGS. 10 to 18 show a second embodiment of a stroller 10 in accordance with the present invention. The stroller 10 of FIGS. 10 to 17 is similar to the previous embodiment and like reference numerals are used to denote like parts.

The front legs 18 are secured to the front wheel support members 24 by brackets 26. The brackets 26 are secured to the front legs 18 and perform as the sleeves 50 of the previous embodiment, in that the brackets comprise tubular members such that the front legs 18 can slide through the brackets 26 longitudinally relative to the front wheel support members 24. The legs 18 and 20 are mounted adjacent front sides of the respective wheel support members 24 and 25.

The extension mechanism on each of the front legs 18 comprises a first link member 28 and a second link member 30. The first link member 28 is pivotally secured at a first end thereof to an angled end portion 32 provided on an upper end of the front leg 18. The second link member 30 is pivotally secured at a first end thereof to a second end of the first link member 28. A second end of the second link member 30 is pivotally secured to the adjacent front wheel support member 24.

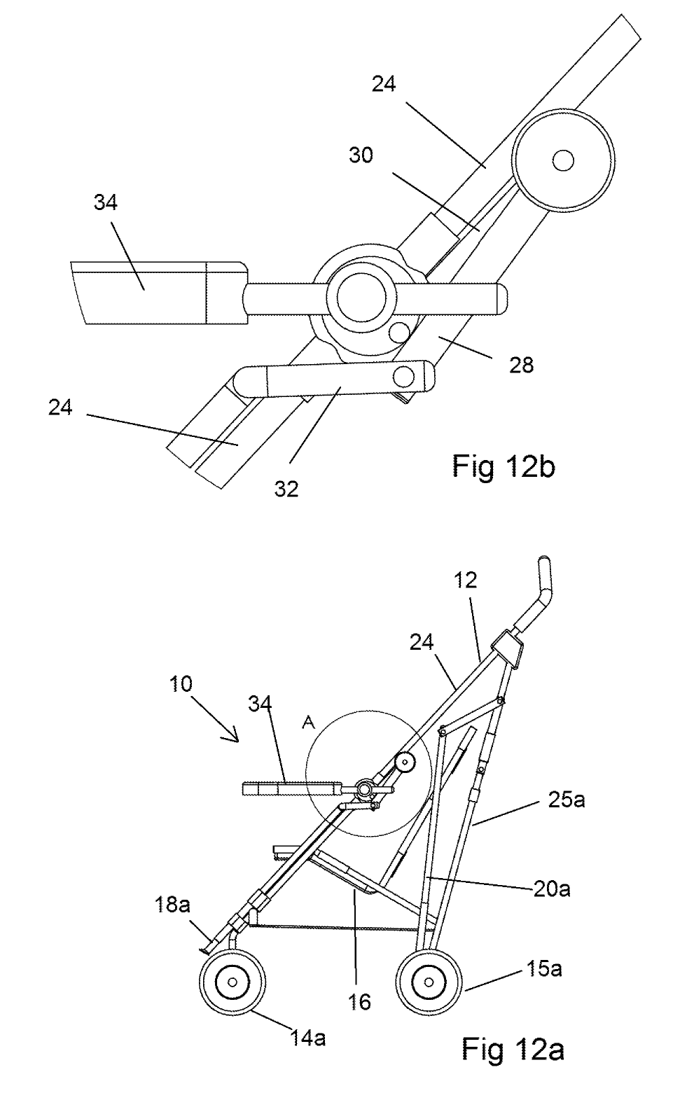

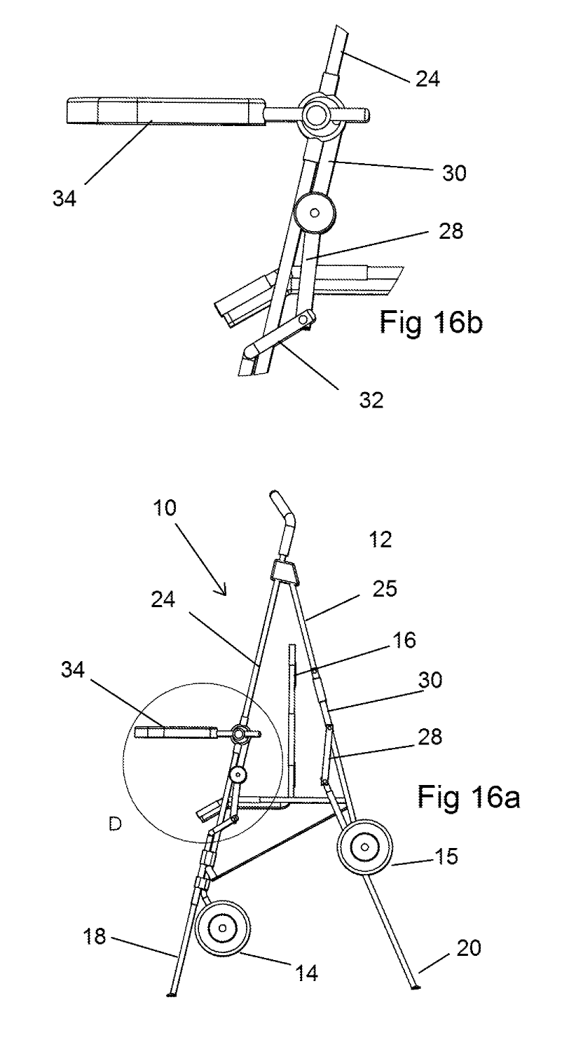

As can be seen in FIGS. 12 and 16, the first and second link members 28 and 30 are pivotable relative to each other between a first position, in which the first and second link members 28 and 30 are adjacent each other (as shown in FIG. 12), and a second position (as shown in FIG. 16), in which the first and second link members 28 and 30 extend generally away from each other. As the second end of the second link member 30 is secured relative to the adjacent front wheel support member 24, this movement from the first position to the second position results in a downward sliding movement of the front leg 18. Rotation of the first and second link members 28 and 30 thereby extends the front leg 18 from the retracted to the extended position. The front legs 18 in the extended position pass in front of the front wheel units 14.

The extension mechanism provided on each of the rear legs 20 comprises also first and second link members 28 and 30. The first link member 28 is pivotally secured at a first end thereof to an upper end of the rear leg 20. The second link member 30 is pivotally secured at a first end thereof to a second end of the first link member 28. A second end of the second link member 30 is pivotally secured to the adjacent rear wheel support member 25. In the extended position, the rear legs 20 pass between the wheels 22 of the rear wheel units 15.

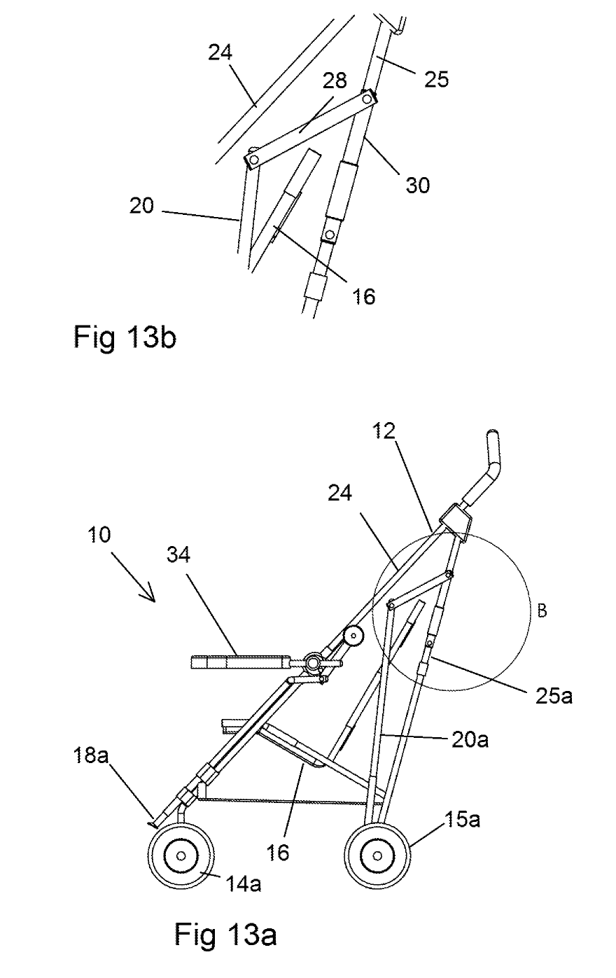

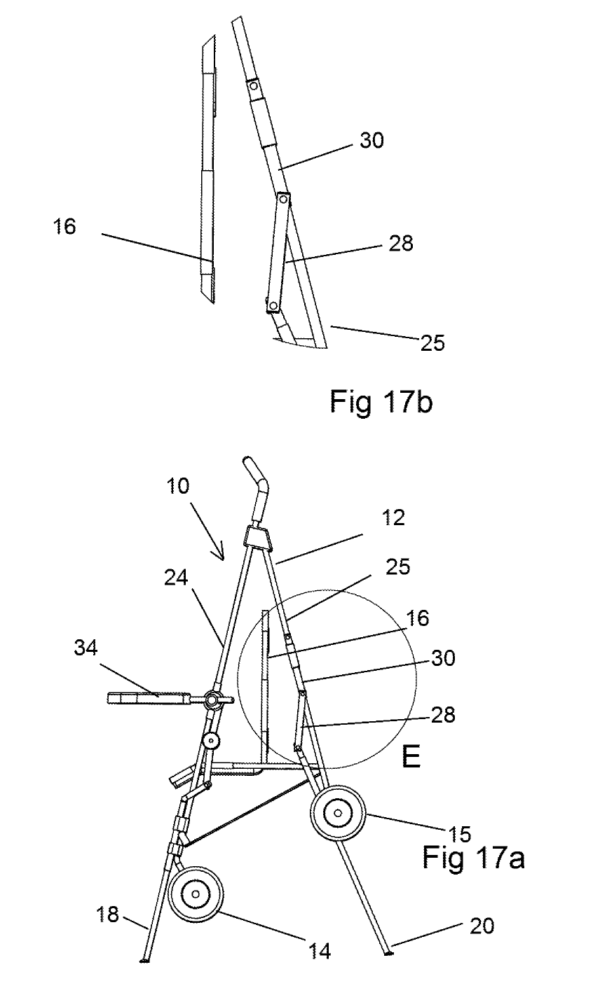

As can be seen in FIGS. 13 and 17, the first and second link members 28 and 30 of the rear legs 20 are also moveable between first and second positions such that in the second position, the rear legs 20 are moved to the extended positions thereof.

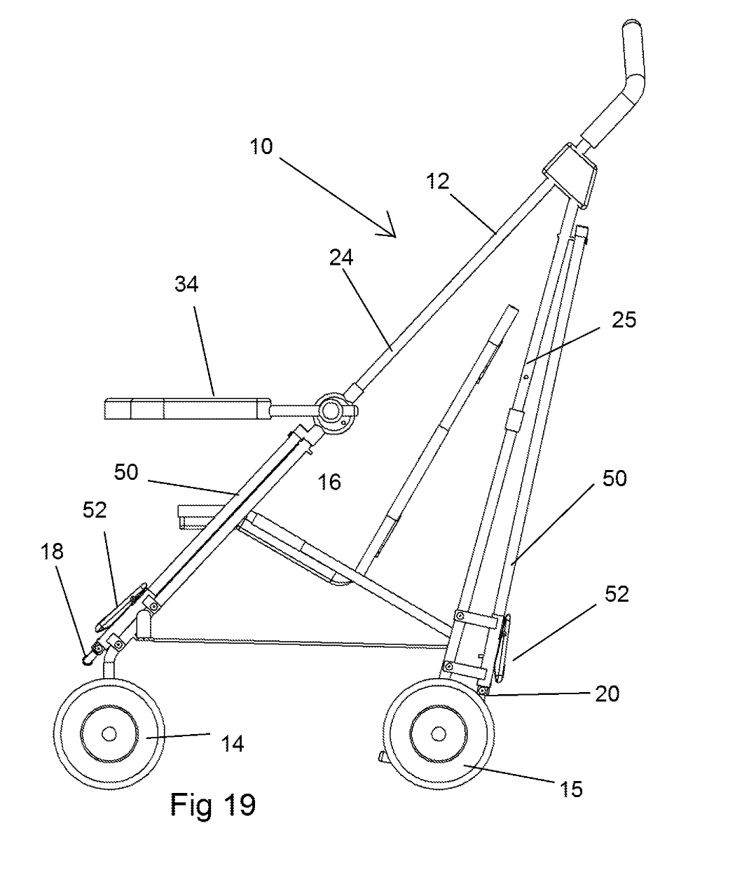

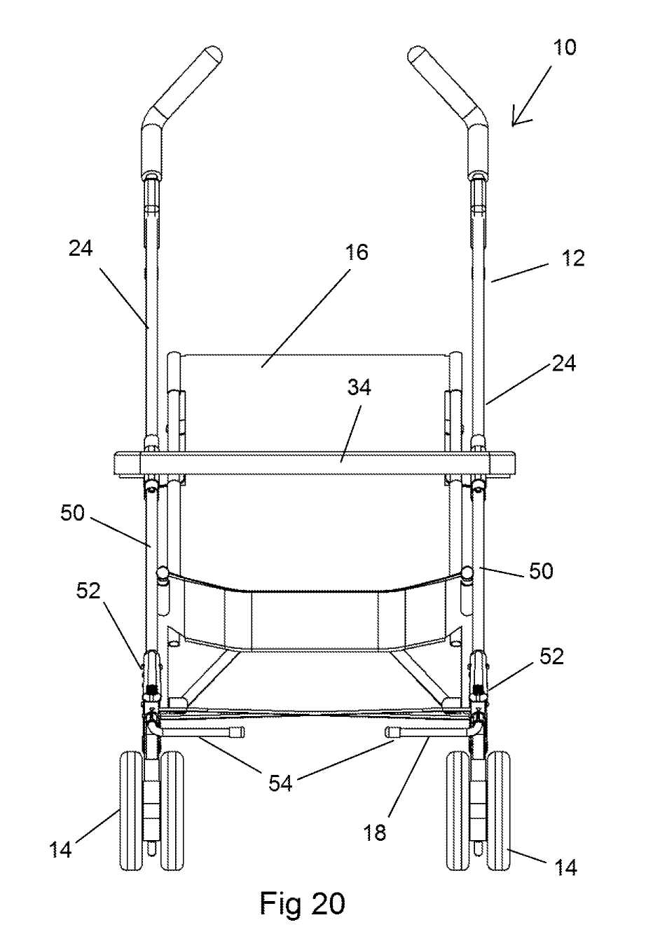

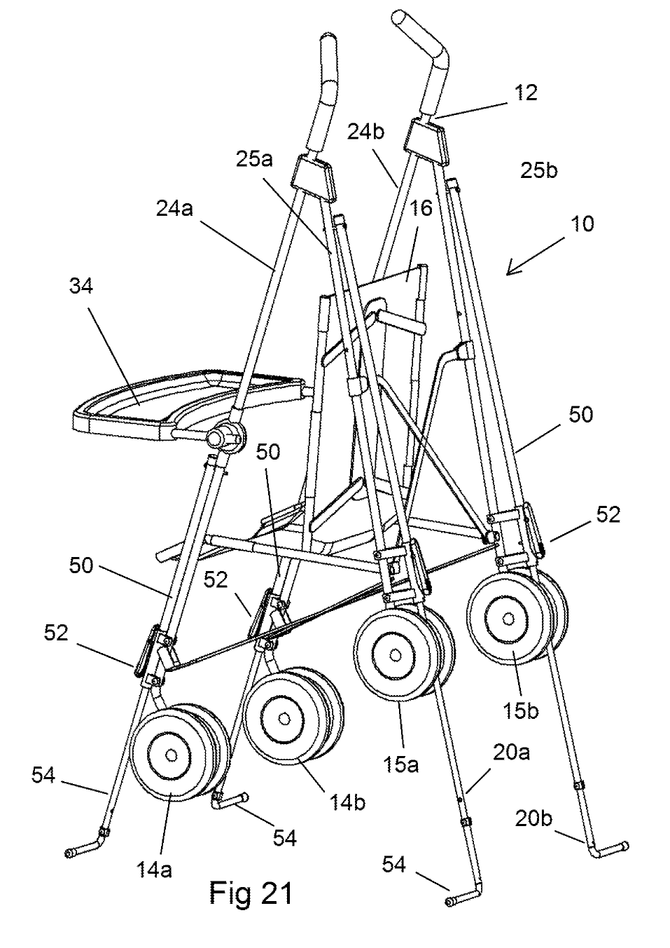

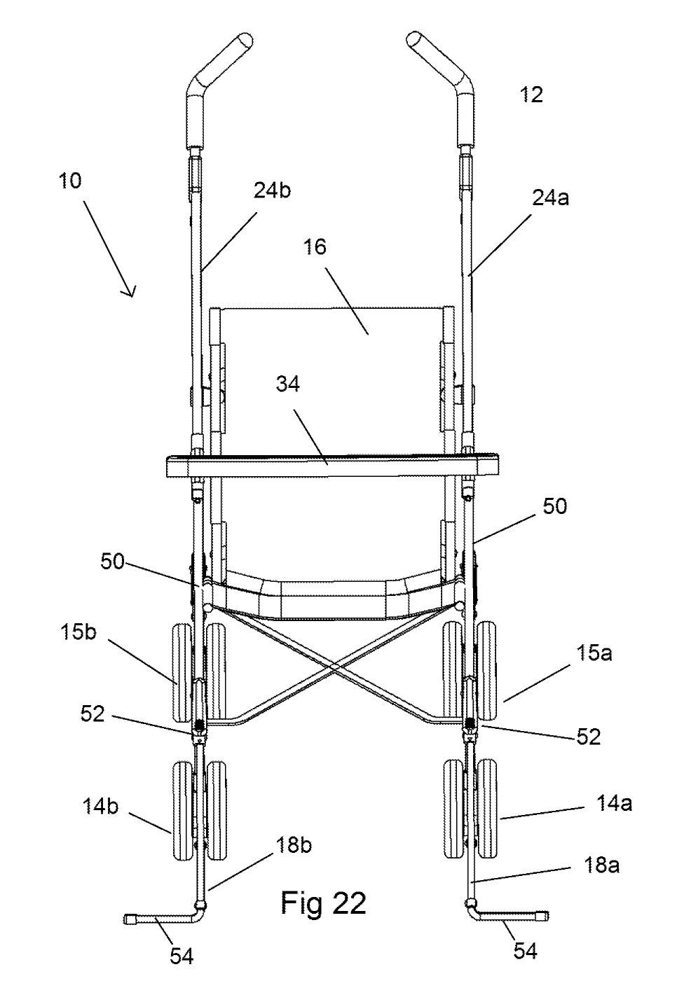

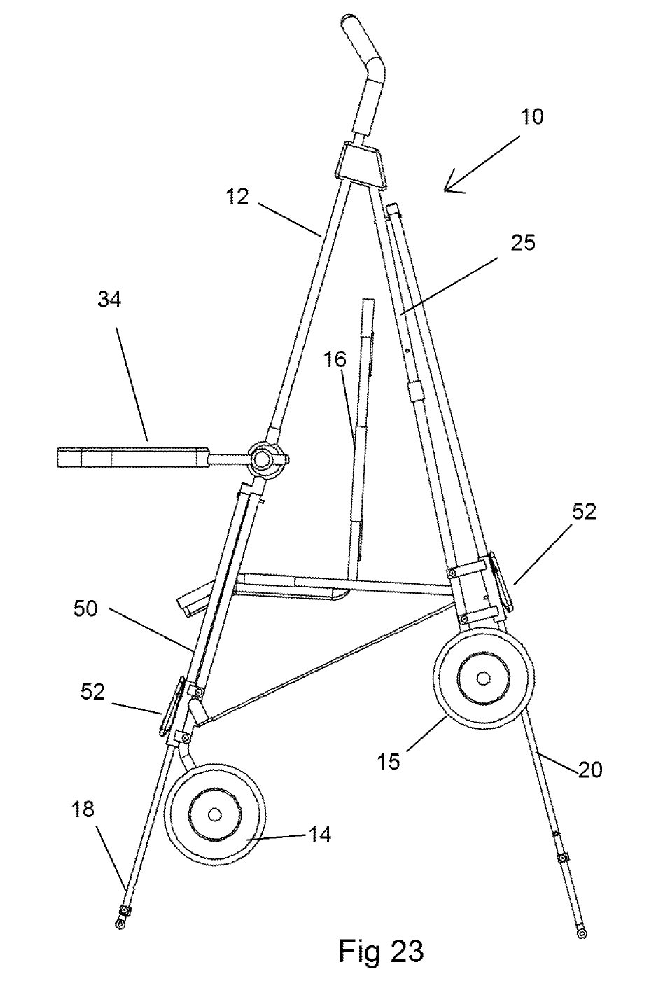

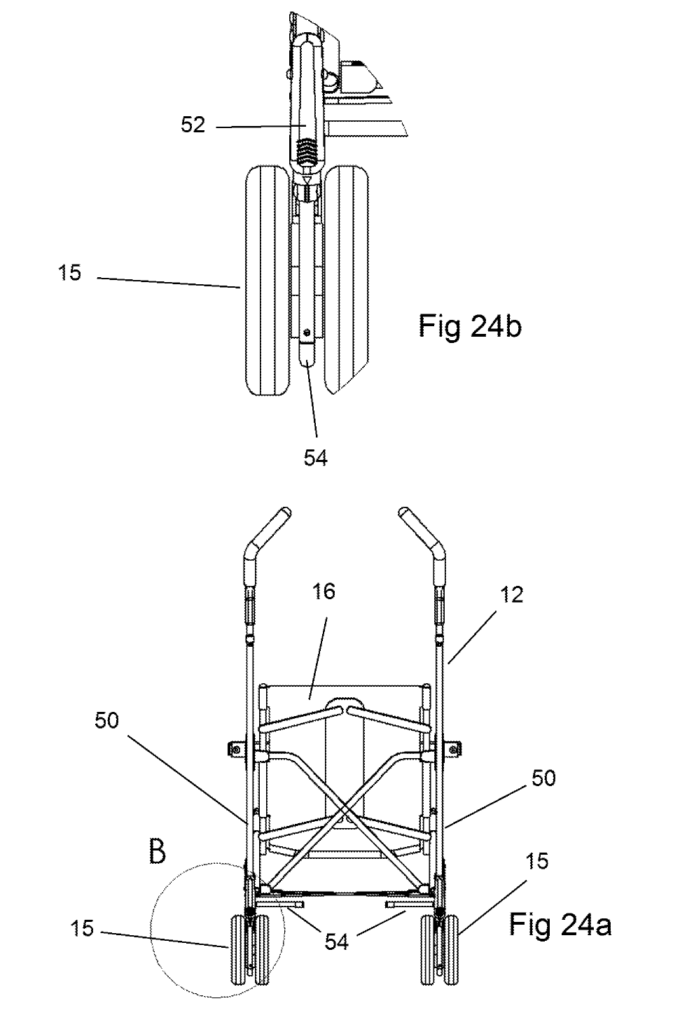

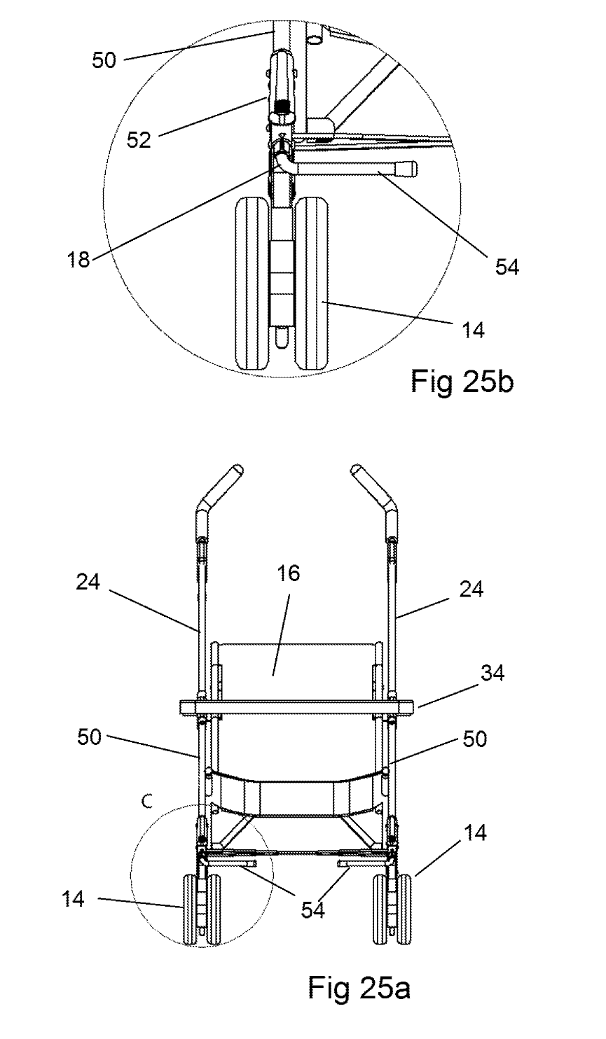

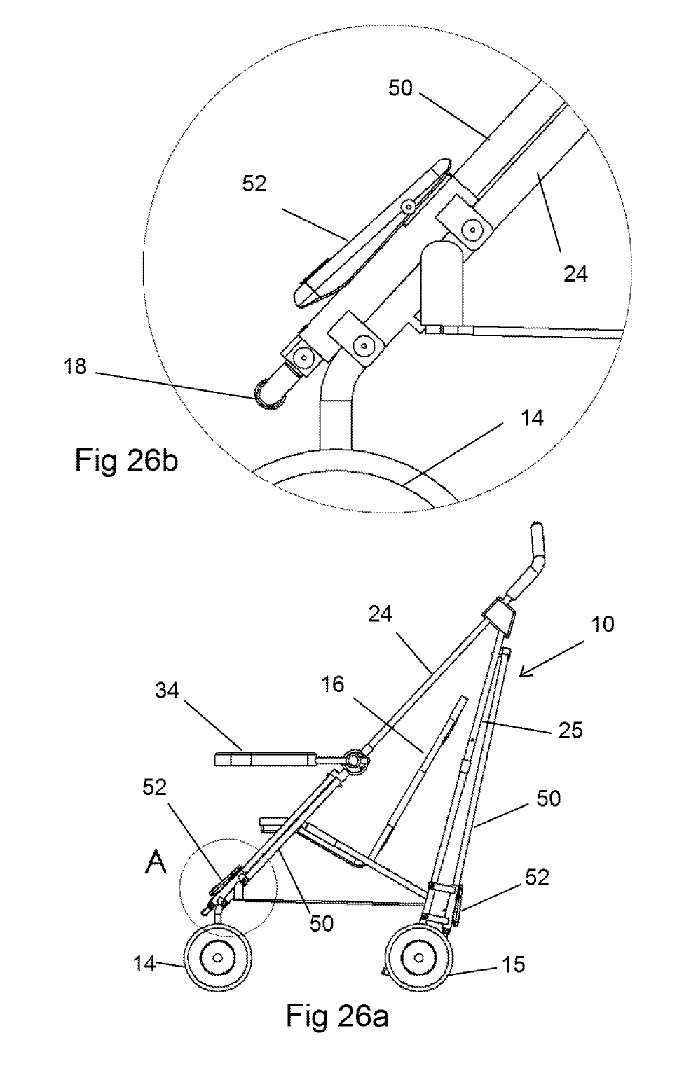

FIGS. 19 to 26 show a third embodiment of a stroller 10 in accordance with the present invention. The stroller 10 of FIGS. 19 to 26 is similar to the embodiment of FIGS. 1 to 9 and like reference numerals are used to denote like parts.

Each of the legs 18 and 20 is provided with a corresponding sleeve 50 secured to the respective wheel support member 24 and 25 within which the leg 18 or 20 can slide. The sleeves 50 of the front legs 18 are secured to the front of the front wheel support members 24 such that the front legs 18, when extended, pass in front of the front wheels 14. The sleeves 50 on the rear wheel support members 25 are located on rear sides thereof such that the rear legs 20, when extended, pass behind the rear wheels 15.

The ends of the legs 18 and 20 in the embodiment of FIGS. 19 to 26 also include transverse end portions 54. The transverse end portions 54 are provided to engage with the ground and provide additional stability.

It will be readily apparent to persons skilled in the relevant arts that various modifications and improvements may be made to the foregoing embodiments, in addition to those already described, without departing from the basic inventive concepts of the present invention.

What is claimed is:

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. A stroller comprising:
first and second front wheel support members, each having a front wheel unit secured to a lower end thereof, and first and second rear wheel support members, each having a rear wheel unit secured to a lower end thereof;
first and second front legs secured to the first and second front wheel support members respectively; and
first and second rear legs secured to the first and second rear wheel support members respectively;
wherein the front and rear legs are each moveable longitudinally from a retracted position, in which the legs are adjacent and parallel to the respective wheel support members with lower ends thereof located above the respective wheel units, to an extended position, in which the lower ends thereof are located below the respective wheel units such that the stroller is supported by the front and rear legs.

20. The stroller in accordance with claim 19, wherein each of the front and rear wheel support members comprises an elongate member and each of the front and rear legs comprises an elongate member mounted parallel to the respective wheel support member and being slidably moveable relative to the respective wheel support member to move between the retracted and extended positions.

21. The stroller in accordance with claim 20, wherein each of the front and rear legs includes an extension mechanism connecting the leg to the adjacent wheel support member, wherein the extension mechanism is operable to move the leg between the extended and retracted positions.

22. The stroller in accordance with claim 21, wherein the rear legs extend such that the lower ends thereof are located at a greater distance from the rear wheel units than the front legs are from the front wheel units such that the seat of the stroller rotates from a more reclined position to a more upright position when the legs move from the retracted to the extended position.

23. The stroller in accordance with claim 22, wherein each of the front and rear legs is provided with a sleeve secured to the respective wheel support member, the sleeves comprising tubular members secured to the wheel support members such that the legs can slide in and out of the lower ends of the sleeve.

24. The stroller in accordance with claim 23, wherein the legs are securable relative to the sleeves by locking members.

25. The stroller in accordance with claim 24, wherein levers are provided adjacent the lower ends of the sleeves operable to disengage the locking members and allow the legs to slide from the retracted position to the extended position and from the extended position to the retracted position.

26. The stroller in accordance with claim 25, wherein the legs are provided with spring biased lugs which extend through holes in the legs and engage into corresponding holes in the sleeves to secure the legs and wherein the levers are provided to depress the lugs to allow the legs to move relative to the sleeves.

27. The stroller in accordance with claim 26, wherein elastic cords are provided connecting the legs to the sleeves such that the legs are biased to move towards the retracted position.

28. The stroller in accordance with claim 27, wherein the sleeves are moveable between first and second positions, such that lower ends of the sleeves move outwardly away from opposed sides of the stroller when moving from the first to the second position.

29. The stroller in accordance with claim 28, wherein the sleeves are pivotally mounted at upper ends thereof to the front and rear wheel support members to pivot between the first and second positions.

30. The stroller in accordance with claim 29, wherein the front and rear wheel support members are provided with mounting members secured thereto, the mounting members including recesses in lower sides thereof into which are received the upper ends of the sleeves such that upper ends of the sleeves are pivotally secured to pins extending across the recesses.

31. The stroller in accordance with claim 30, wherein each of the sleeves pivots between the first position in which the sleeve is adjacent and parallel to the respective wheel support member and the second position in which the sleeve extends at an angle to the wheel support member.

32. The stroller in accordance with claim 28, wherein each of the sleeves is provided with an extension member adjacent the lower end thereof, the extension members connecting between the wheel support member and the sleeve such that the extension member moves the sleeve between the first and second positions.

33. The stroller in accordance with claim 32, wherein the extension member comprises a first arm portion and a second arm portion, a first end of the first arm portion being pivotally mounted to the wheel support member, a second end of the first arm portion being pivotally secured to the second arm portion and a second end of the second arm portion being pivotally secured to the sleeve.

34. The stroller in accordance with claim 33, wherein the first and second arm portions can move between a first position in which the arm portions are adjacent and parallel to each other, and a second position, in which the arm portions are collinear and extend outwardly from the wheel support member to the sleeve.

35. The stroller in accordance with claim 23, wherein the sleeves comprise brackets secured adjacent lower ends of the wheel support members and the extension mechanism comprises a first link member and a second link member, the first link member being pivotally secured at a first end thereof to the leg and the second link member being pivotally secured to the first link member and the adjacent wheel support member, wherein the first and second link members are pivotable relative to each other from a first position, in which the first and second link members are adjacent each other, to a second position, in which the first and second link members extend generally away from each other to move the legs to the extended positions.

36. The stroller in accordance with claim 19, wherein the frame is provided with a table secured between the first and second front wheel support members such that the table is located in front of the seat.

37. The stroller in accordance with claim 19, wherein each of the front and rear legs is provided with a sleeve secured to the respective wheel support member, the sleeves comprising tubular members secured to the wheel support members such that the legs can slide in and out of the lower ends of the sleeve.

38. The stroller in accordance with claim 23, wherein the sleeves are moveable between first and second positions, such that lower ends of the sleeves move outwardly away from opposed sides of the stroller when moving from the first to the second position.
